(19) United States
(12) Patent Application Publication
(10) Pub. No.: US 2012/0134913 A1
(43) Pub. Date: May 31, 2012

(54) METHOD FOR PRODUCING CHLORINE BY GAS PHASE OXIDATION OF HYDROGEN CHLORIDE IN A FLUIDIZED-BED REACTOR

(75) Inventors: Martin Karches, Neustadt (DE); Kati Bachmann, Viernheim (DE); Martin Sesing, Waldsee (DE); Lothar Seidemann, Speyer (DE); Michael Pilz, Hemsbach (DE)

(73) Assignee: BASF SE, Ludwigshafen (DE)

(21) Appl. No.: 13/389,081

(22) PCT Filed: Jul. 28, 2010
(86) PCT No.: PCT/EP10/60943

§ 371 Date: Feb. 6, 2012

(30) Foreign Application Priority Data
Aug. 5, 2009 (EP) 09167250.1

(51) Int. Cl. C01B 7/04

(52) U.S. Cl. 423/502

(57) ABSTRACT

A process for preparing chlorine by gas-phase oxidation of hydrogen chloride over a heterogeneous, particulate catalyst in a fluidized-bed reactor to give a product gas mixture which is freed of entrained catalyst particles in cyclones (1) which are arranged in the upper region of the fluidized-bed reactor, which comprises a cylindrical upper part (2) which has a tangential or spiral-shaped inlet (3) for the product gas mixture and tapers at its lower end via a conical section (4) into a cyclone downcomer tube (5) and also a central downward-extending tube (6) in the upper region of the cyclone (1) for discharging the product gas mixture which has been freed of entrained catalyst particles, wherein

from one to seven cascades of in each case from two to five cyclones (1) connected in series are used, with the cyclones (1) of each cascade, with the exception of the first cyclone (1) through which flow occurs in each case, which is designed so that about 90 to 99% by weight of the entrained catalyst particles are precipitated, each having a trickle valve (7) comprising an angled tube end piece (8) and also a loose flap (9) suspended at an angle α to the vertical at the lower end of the cyclone downcomer tube (5), where the angle α and the weight of the flap (9) are designed so that the torque of the flap (9) divided by the diameter of the outlet opening from the angled tube end piece (8) is in the range from 2 to 300 N/m², is proposed.

The invention relates to a process for preparing chlorine by gas-phase oxidation of hydrogen chloride in a fluidized-bed reactor.

The preparation of chlorine by gas-phase oxidation of hydrogen chloride over a heterogeneous, particulate catalyst by the Deacon process is known and can be carried out on an industrial scale in, for example, fluidized-bed reactors, as described in WO 2005/092488.

Mass transfer in a fluidized bed and thus also the conversion of the reactants is influenced decisively by, in particular, catalyst particles having a size in the range from about 15 to 45 μm (cf. Chemical Reaction Eng., Proceedings of the fifth European/second international symposium on chemical reaction eng., Amsterdam, May 2, 3 and 4, 1972).

Known devices for keeping catalyst particles back from the product gas stream from fluidized-bed reactors, in particular cyclones or filters, have only a limited ability to hold back catalyst particles, in particular catalyst particles in the size range from about 15 to 45 μm which is particularly important for mass transfer. However, catalyst particles in the above size range which is particularly important for mass transfer which are entrained in the product gas stream should as far as possible be recirculated to the fluidized bed. Smaller catalyst particles having an average particle size of <15 μm should preferably also be very largely collected in order to recover the expensive catalyst and to prevent them causing problems in downstream parts of the plant, in particular leading to deposits on the heat exchanger tubes and possibly also conglutinations. This fine fraction should not be recycled unchanged to the fluidized bed.

It was therefore an object of the invention to provide a process for preparing chlorine by gas-phase oxidation of hydrogen chloride over a heterogeneous, particulate catalyst in a fluidized-bed reactor, in which the catalyst particles discharged from the fluidized bed, in particular the fraction having a size range from about 15 to 45 μm, are recirculated to the fluidized bed.

The object is achieved by a process for preparing chlorine by gas-phase oxidation of hydrogen chloride over a heterogeneous, particulate catalyst in a fluidized-bed reactor to give a product gas mixture which is freed of entrained catalyst particles in cyclones which are arranged in the upper region of the fluidized-bed reactor, which comprises a cylindrical upper part which has a tangential or spiral-shaped inlet for the product gas mixture and tapers at its lower end via a conical section into a cyclone downcomer tube and also a central downward-extending tube in the upper region of the cyclone for discharging the product gas mixture which has been freed of entrained catalyst particles, wherein from one to seven cascades of in each case from two to five cyclones connected in series are used, with the cyclones of the cascade, with the exception of the first cyclone through which flow occurs in each case, which is designed so that at least 90% by weight of the entrained catalyst particles are precipitated, each having a trickle valve comprising an angled tube end piece and also a loose flap suspended at an angle α to the vertical at the lower end of the cyclone downcomer tube, where the angle α and the weight of the flap are designed so that the torque of the flap divided by the diameter of the outlet opening from the angled tube end piece is in the range from 2 to 300 N/m².

The gas-phase oxidation of hydrogen chloride by means of an oxygen-comprising gas stream in the presence of a heterogeneous, particulate catalyst by the Deacon process is known.

The Deacon process can be carried out in various apparatuses, in particular in fluidized-bed reactors as provided by the present invention. Fluidized-bed reactors generally have an at least approximately rotationally symmetric, in particular cylindrical, geometry. The starting materials, viz. hydrogen chloride and an oxygen-comprising gas stream, are fed into the fluidized-bed reactor from below via a gas distributor, in particular a perforated plate or a plate having gas distributor nozzles arranged therein, with the process conditions being set so that a heterogeneous, particulate catalyst forms a fluidized bed.

As catalysts, preference is given to using supported catalysts which comprise one or more metal components on an oxidic support. Metal components are, for example, ruthenium or copper compounds. As oxidic supports, it is possible to use aluminum oxide, in particular γ-aluminum oxide or δ-aluminum oxide, zirconium oxide, titanium oxide or mixtures thereof.

When the fluidized-bed reactor is used for the oxidation of hydrogen chloride to chlorine, it is possible to use, for example, the ruthenium-based catalysts known from GB 1,046,313, DE-A 197 48 299 or DE-A 197 34 412. Furthermore, the gold-based catalysts comprising from 0.001 to 30% by weight of gold, from 0 to 3% by weight of one or more alkaline earth metals, from 0 to 3% by weight of one or more alkali metals, from 0 to 10% by weight of one or more rare earth metals and from 0 to 10% by weight of one or more further metals selected from the group consisting of ruthenium, palladium, osmium, iridium, silver, copper and rhenium, in each case based on the total weight of the catalyst, on a support which are described in DE-A 102 44 996 are also suitable.

To produce the catalyst, a γ-aluminum oxide powder is preferably impregnated with an aqueous ruthenium chloride hydrate solution in an amount corresponding to the water uptake of the support, subsequently dried at from 100 to 200° C. and finally calcined at 400° C. in an air atmosphere. The ruthenium content of the catalyst is preferably from 1 to 5% by weight, in particular from 1.5 to 3% by weight.

The process is preferably carried out as described in WO 2005/092488 by controlling the temperature distribution within the fluidized bed by arranging one or more heat exchangers in the fluidized bed so that the temperature profile in the main flow direction along the rotational axis of the fluidized-bed reactor has a temperature difference between the lowest temperature and the highest temperature of at least 10 kelvin.

The product gas mixture leaving the fluidized bed at the upper end entrains part of the catalyst particles from the bed. To minimize the loss of entrained catalyst particles, from one to seven cascades of in each case from two to five cyclones connected in series are provided in the upper region of the fluidized-bed reactor according to the process of the invention. Here, the term cascade refers, as usual, to an arrangement of apparatuses, in the present case cyclones, connected in series.

Each cyclone comprises, in a manner known to those skilled in the art, a cylindrical upper part having a tangential or spiral inlet for the mixture to be separated, in the present case the product gas mixture, with the cylindrical upper part tapering at its lower end via a conical section to a cyclone downcomer tube. As a result of the tangential or spiral inlet, spiral downward motion is imparted to the product gas mixture to be separated, with the solid catalyst particles comprised therein precipitating on the walls of the cyclone and being discharged in a downward direction via the cyclone downcomer tube. The gas stream which has been purified in the cyclone leaves the latter in its upper region via a central downward-extending tube.

According to the invention, at least one cascade of in each case from two to five cyclones connected in series is used, with the cyclone through which flow occurs first of each cascade being designed so that at least 90% by weight of the entrained catalyst particles are precipitated therein.

The design of the cyclone is carried out in a manner known to those skilled in the art, generally according to the model of Barth-Muschelknautz, in particular taking into account the pressure drop and the degree of precipitation which are first and foremost dependent on the circumferential velocities in the interior of the cyclone (cf. VDI-Wärmeatlas, 8th edition, 1979, Lja1-Lja11).

The cyclone through which flow occurs first of the one or more cascades is, in particular, designed so that the cyclone downcomer tube dips into the fluidized bed. This prevents bypasses of product gas mixture via the cyclone downcomer tube or ensures that the product gas mixture passes through the cyclone exclusively or virtually exclusively via the tangential inlet.

An angled lower pipe end piece can advantageously join the lower end of the cyclone downcomer tube of the cyclone through which flow occurs first of the one or more cascades.

In a further preferred embodiment, an impingement plate can be arranged below the lower end of the cyclone downcomer tube.

The further, one to four cyclones of each cascade are each equipped at the lower end of the cyclone downcomer tube with a trickle valve which in each case has, as customary, an angled pipe end piece and a loose flap suspended at an angle α, which is different from zero, to the vertical. The flap has to rest fully against the angled lower pipe end piece adjoining the cyclone downcomer tube; thus, this end piece has to be angled to above the vertical position. The lower end of the cyclone downcomer tube is closed by a trickle valve in order to reduce or minimize bypass of gas via this.

The inventors have recognized that it is possible to design the flap so that the precipitated solid additionally seals the flap against bypass of gas while at the same time ensuring that the cyclone is not flooded by precipitated solid.

Contrary to the view expounded in the specialist publication “Hydrocarbon Processing”, May 2007, pp. 75-84, that the weight of the flap has no influence on the bypass of gas, it has been found that the torque of the flap, which is dependent on the angle of the flap relative to the vertical and the weight of the flap, in the abovementioned range from about 2 to 300 N/m² gives minimal bypass of gas and thus a minimal loss of expensive catalyst.

To achieve the above values for the torque of the flap, the angle α of the flap to the vertical is, in particular, set in the range from 1 to 5° and can vary in a relatively wide range from about 0.1 to 100 kg because it is dependent on the size of the flap which in turn depends on the outlet opening of the tube.

The flaps are preferably designed so that they have a torque in the range from 10 to 200 N/m², in particular in the range from 30 to 100 N/m². The flaps are more preferably designed so that they have an increasing torque with rising position of the respective cyclone in the cascade.

Preference is given to using from one to five cascades of cyclones, in particular from two to three cascades of cyclones.

Each cascade comprises, in particular, two or three cyclones.

It is possible to use cyclones having an identical construction within a cascade. In the case of a plurality of cascades, these can each have an identical construction.

To achieve further precipitation of solid catalyst particles, the product gas stream which has been largely purified in the one or more cascades of cyclones can additionally be passed through a filter located outside the fluidized-bed reactor. This filter can, in particular, be designed so that it retains catalyst particles having a diameter of <15 μm. In addition, nickel chloride which can be formed in the reaction is also retained in the external filter.

The process is advantageously carried out with injection of inert gas.

Inert flushing gas is preferably introduced into the cyclones equipped with flaps
at the interior wall of the angled tube end piece, at the position A at which the extension of the central line of the cyclone downcomer tube meets the interior wall of the tube and/or
at a position B which is located downstream of the position A and/or
at a position C on the cyclone downcomer tube, preferably at its lower end.

The introduction of inert flushing gas brings the following advantages:

Very fine particles of solid seal the flap; complete or partial defluidization of the catalyst solid occurs, the solid particles rest against the wall and form bridges of solid. Sufficient force to open the flap can then no longer be applied to the flap, i.e. the flap becomes blocked. The introduction of gas loosens the particles of solid and the flap opens.

The introduction of inert flushing gas can be carried out at any of the three points A to C alone or at any desired combination of the positions A, B and C.

A further advantage of the introduction of inert flushing gas is that it is possible to check the function of a trickle valve by measuring the differential pressure between two gas introduction lines or by measuring the differential pressure between a gas introduction line and the top of the reactor, since the pressure drop is a measure of the amount of solid precipitated between the two measurement points.

The invention is illustrated below with the aid of a drawing and an example. In the drawing,

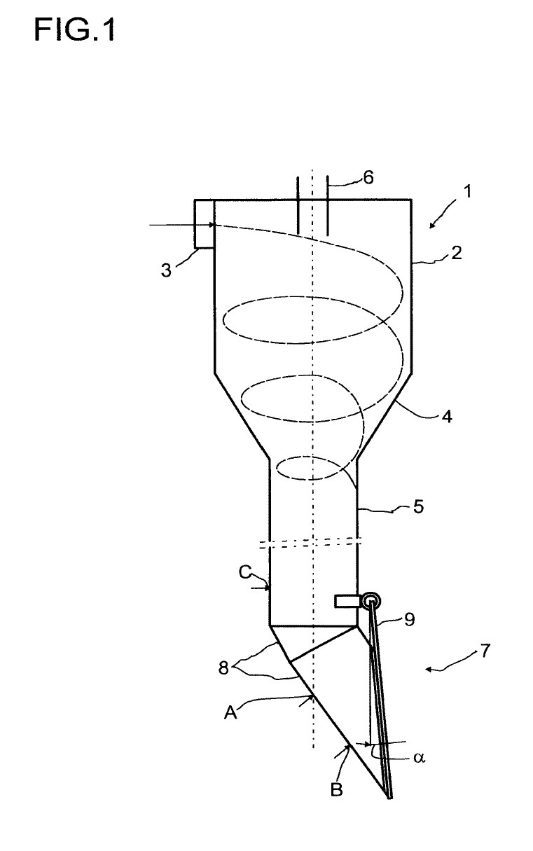

FIG. 1 schematically shows a preferred embodiment of a cyclone for use in the process of the invention,

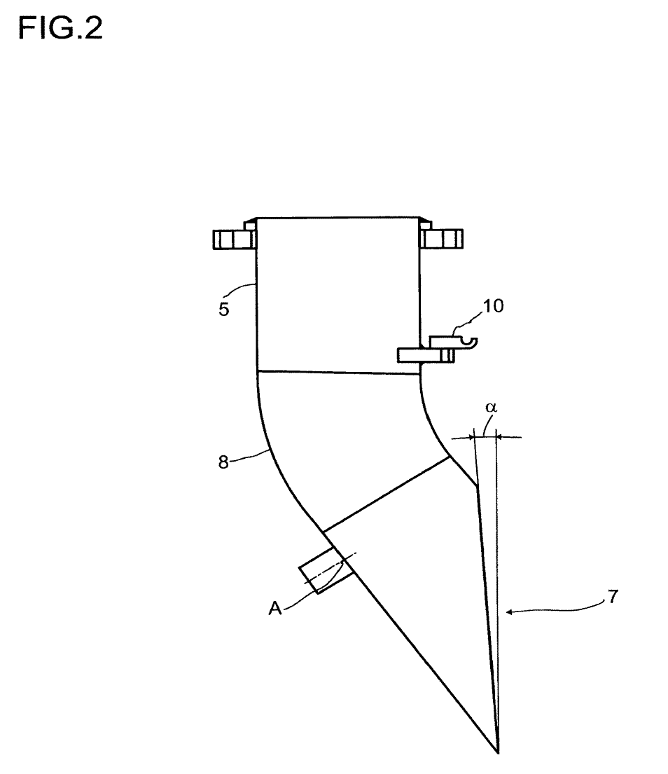

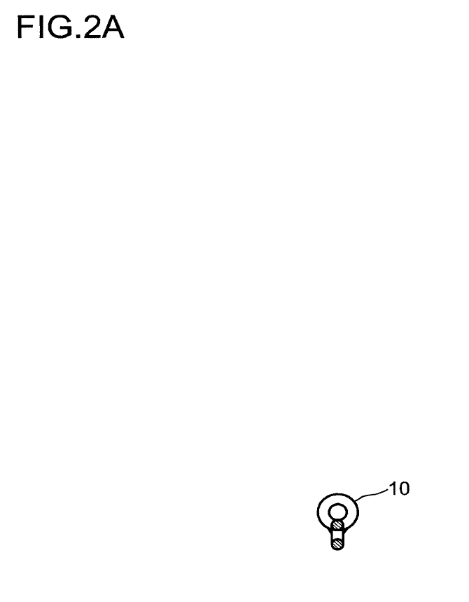

FIG. 2 shows a preferred embodiment of a trickle valve with depiction of the suspension for the flap, with detailed view of the suspension for the flap in FIG. 2A,

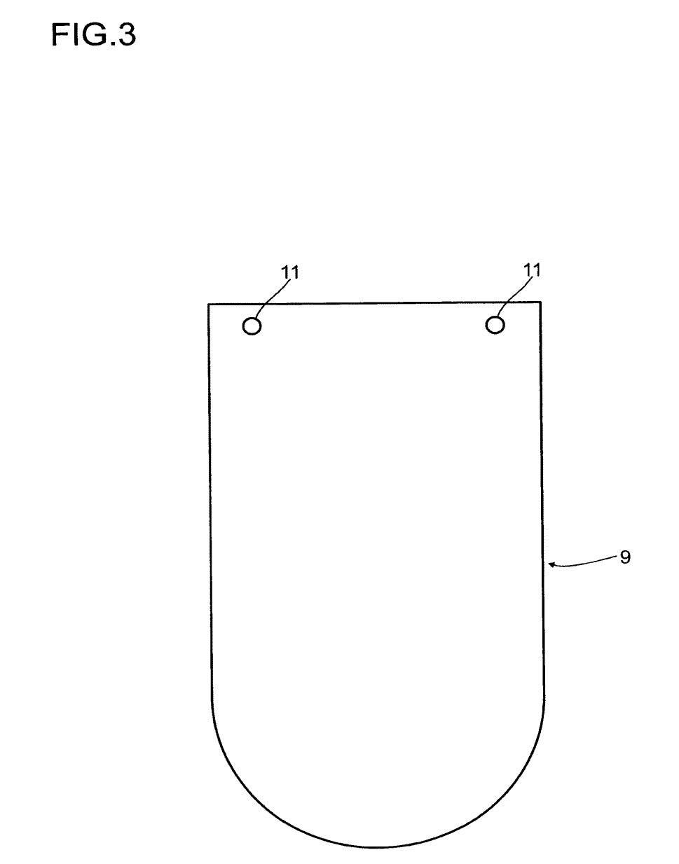

FIG. 3 schematically shows a plan view of a flap,

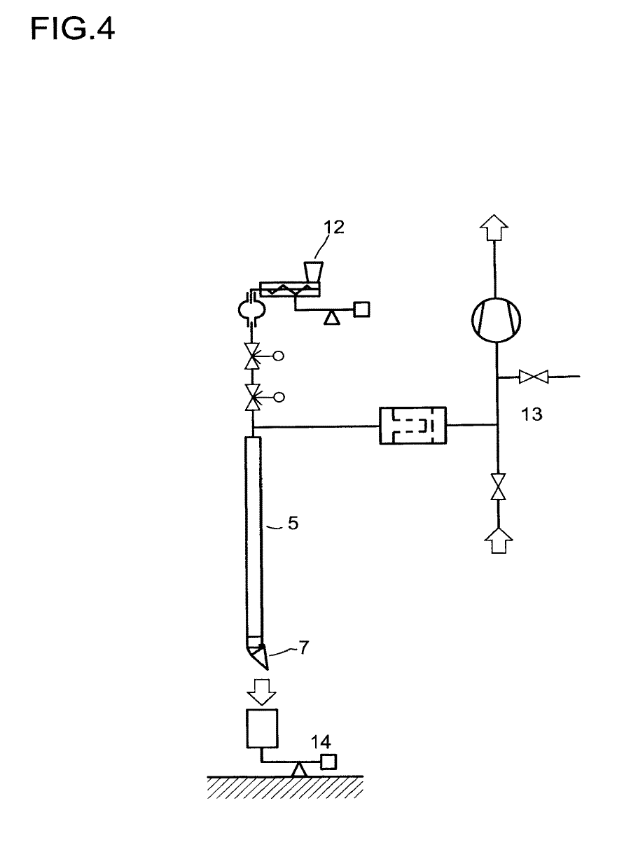

FIG. 4 schematically shows a pilot plant which depicts a cyclone downcomer tube used for carrying out the process of the invention and

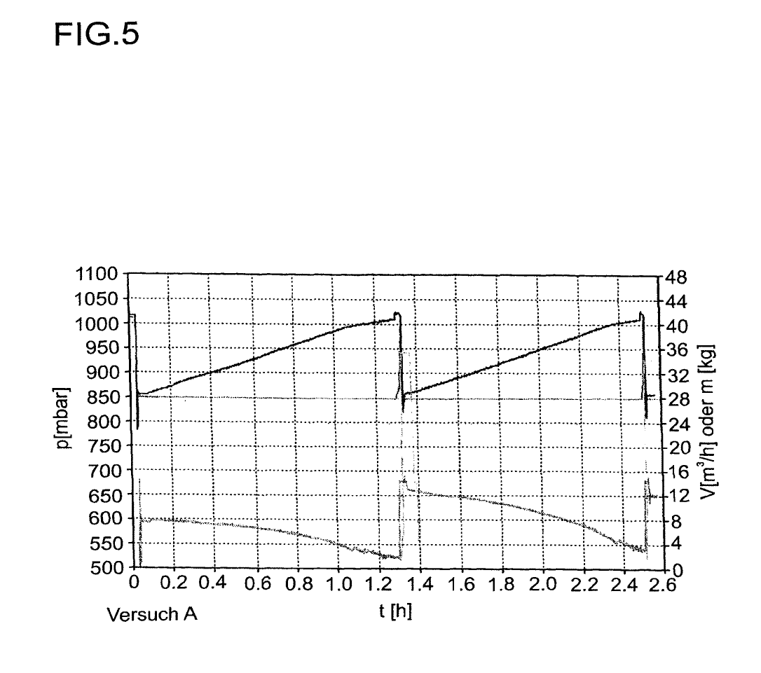

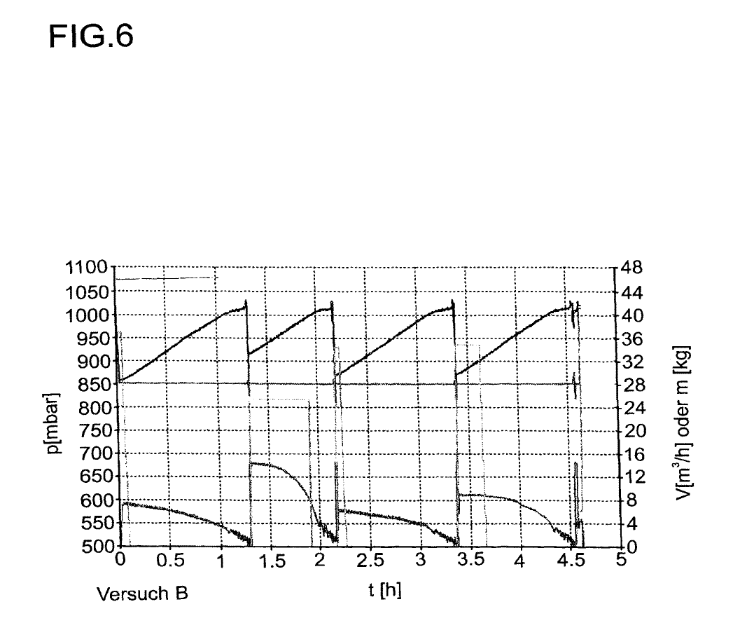

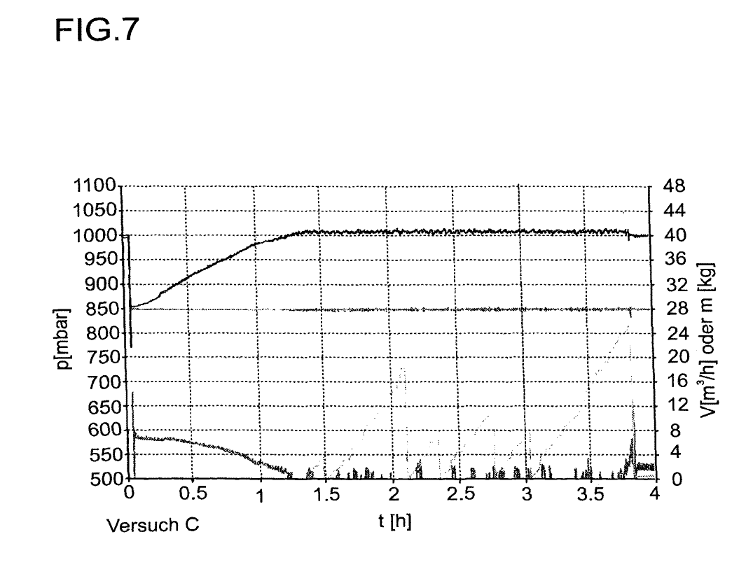

FIGS. 5 to 7 show the results of experiments using the pilot plant shown in FIG. 4, with different flap weights.

In the figures, identical reference numerals denote the same or corresponding features.

FIG. 1 schematically shows a cyclone 1 having a cylindrical upper part 2 with a tangential inlet 3 for the product gas mixture which tapers via a conical section 4 to a cyclone downcomer tube 5, having a central downward-extending tube 6 in the upper region of the cyclone for discharge of the product gas mixture which has been freed of entrained catalyst particles and having a trickle valve 7 at the lower end of the cyclone downcomer tube 5, which trickle valve 7 comprises an angled tube end piece 8, which in the preferred embodiment depicted in the figure is made up to two parts, and a loose suspended flap 9 at an angle α to the vertical.

FIG. 2 shows an enlarged depiction of the lower end of a cyclone downcomer tube 5 with adjoining trickle valve 7 comprising an angled tube end piece 8. An inlet for inert gas is arranged by way of example at the position A at which the central axis of the cyclone downcomer tube 5 meets the interior wall of the angle tube end piece 8. The angled tube end piece 8 ends in an angle α which deviates slightly, in the present case, by way of example, by 3°, from the vertical. A suspension device 10 for the flap which is not shown in FIG. 2 (reference numeral 9 in FIG. 1) is provided at the lower end of the cyclone downcomer tube 5.

FIG. 2A shows an enlarged depiction of the suspension device 10.

FIG. 3 schematically shows a preferred embodiment of a flap 9 having, by way of example, two openings 11 in the upper region of the flap 9 by means of which the flap 9 is suspended in appropriate suspension devices 10.

FIG. 4 schematically shows a pilot plant which simulates a cyclone downcomer tube 5 with trickle valve 7.

Solid is introduced into the cyclone downcomer tube by means of a solids metering facility 12, the pressure regulator 13 simulates the subatmospheric pressure in the cyclone downcomer tube and the precipitated solid is weighed on the balance 14.

FIGS. 5 to 7 show the results of the examples which were carried out in a pilot plant as shown in FIG. 4.

### EXAMPLES

In experiments A and B, the product is in each case metered at 30 kg/h into the downcomer tube at a set and regulated subatmospheric pressure of 850 mbar. In addition, a small amount of gas of about 200 I/h is added via the gas inlet. The difference between the two experiments is in the flap and its weight.

In experiment A (see graph for experiment A), only the flap (about 3 kg intrinsic weight) without additional weight is used. After about 1.2-1.3 h, the flap opens and just under 35 kg of product run out. The downcomer tube is thus empty after each opening and the amount of leakage gas is accordingly high.

In experiment B (see graph for experiment B), this flap is then used with an added weight of 10 kg. Here too, the flap opens after about 1-1.3 h. The amount of product running out is here in each case 25-35 kg. Here too, the downcomer tube is virtually empty after opening. When the amounts of leakage gas in the two experiments are compared, a difference is found. In experiment B) this amount of gas is on average somewhat smaller than in experiment A. However, since these amounts of gas should be minimized further, the flap was loaded with a further 10 kg in the next experiment C (total weight now about 23 kg).

In experiment C (see graph for experiment C), the particles are likewise fed in at 30 kg/h and about 200 I/h of gas are introduced. After about 1-1.5 h, the solid trickles continuously but slowly out from the cyclone downcomer tube. During this time, significant fluctuations are observed neither in the pressure nor in the amount of leakage gas. This means that the particles retained in the cyclone downcomer tube by the heavy flap seal the flap opening.

1. A process for preparing chlorine, the process comprising:
oxidizing hydrogen chloride in the gas-phase over a heterogeneous particulate catalyst in a fluidized-bed reactor, to obtain a product gas mixture;
flowing the product gas mixture through cyclones are arranged in an upper region of the fluidized-bed reactor, to obtain a product gas mixture which is freed of entrained catalyst particles,
wherein each cyclone comprises:
a cylindrical upper part comprising a tangential or spiral-shaped inlet for the product gas mixture;
a cyclone downcomer tube; and
a central downward-extending tube in an upper region,
wherein the cylindrical upper part tapers at a lower end via a conical section into the cyclone downcomer tube; and the product gas mixture which has been freed of entrained catalyst particles is discharged from the central downward-extending tube,
wherein the fluidized-bed reactor comprises one to seven cascades each case each individually comprising two to five cyclones connected in a series,
wherein a first cyclone through which flow occurs first in each cascade is designed to precipitate at least 90% by weight of the entrained catalyst particles,
wherein the cyclones of each cascade, with the exception of the first cyclone each comprise a trickle valve comprising an angled tube end piece and a loose flap suspended at an angle α to the vertical at a lower end of the cyclone downcomer tube, wherein the angle α and a weight of the flap are designed so that a torque of the flap divided by a diameter of an outlet opening from the angled tube end piece is in the range from 10 to 300 N.

2. The process of claim 1, wherein the cyclone downcomer tube of the first cyclone in each cascade dips into the fluidized bed.

3. The process of claim 1, wherein the fluidized-bed reactor further comprises an impingement plate, which is arranged at a distance below the lower end of the cyclone downcomer tube of the first cyclone.

4. The process of claim 1, wherein the cyclone downcomer tube of the first cyclone comprises an angled lower tube end piece.

5. The process of claim 1, wherein the fluidized-bed reactor comprises one to five cascades.

6. The process according of claim 1, wherein the fluidized-bed reactor comprises two to three cyclones per cascade.

7. The process of claim 1, wherein each cyclone within a cascade has an identical construction.

8. The process of claim 1, wherein each cascade has an identical construction.

9. The process of claim 1, wherein the torque of the flap divided by the diameter of the outlet opening is in a range from 10 to 200 N/m².

10. The process of claim 9, wherein the torque of the flap divided by the diameter of the outlet opening is in a range from 30 to 100 N/m².

11. The process of claim 1, wherein the angle α is in a range from 1 to 5°.

12. The process of claim 1, wherein the torque of the flap increases with ascending position of the cyclone.

13. The process of claim 1, wherein a filter is provided downstream from one to seven cascades.

14. The process of claim 1, further comprising:
flushing the cyclones equipped with flaps with an inert gas at one or more positions selected from the group consisting of:
a position (A) where an extension of a central line of the cyclone downcomer tube meets an interior wall of the angled tube end piece;
a position B downstream from the position A; and
a position C on the cyclone downcomer tube.

15. The process of claim 14, wherein the position C is at a lower end of the cyclone downcomer tube.

16. The process of claim 14, comprising flushing at the position A.

17. The process of claim 14, comprising flushing at the position B.

18. The process of claim 14, comprising flushing at the position C.

19. The process of claim 16, comprising flushing at the position B.

20. The process of claim 16, comprising flushing at the position C.
